(19) United States
(12) Patent Application Publication
(10) Pub. No.: US 2024/0327096 A1
(43) Pub. Date: Oct. 3, 2024

(54) Test Arrangement for the Detection of a Substance

(71) Applicant: Seitz Hiemer Sogaro GbR, Durrwangen (DE)

(72) Inventors: Andreas Hiemer, Hamburg (DE); Alberto C. Sogaro, Bad Homburg (DE); Sebastian Seitz, Durrwangen (DE)

(21) Appl. No.: 18/617,877

(22) Filed: Mar. 27, 2024

(30) Foreign Application Priority Data
Mar. 31, 2023 (DE) 23 165 995.4

(51) Int. Cl. B65D 81/32

(52) U.S. Cl. CPC B65D 81/3222

(57) ABSTRACT

A test arrangement for the detection of a substance in which the testing arrangement includes a plastic sleeve, an ampule which holds a test liquid and which is disposed in the plastic sleeve, a container having a mixing space for holding and for mixing the test liquid and the substance, an activation element whose actuation causes a breaking open of the ampule so the test liquid is released to the mixing space, and a test swab for being immersed in the mixing space.

### CROSS-REFERENCE TO RELATED APPLICATION

This application claims priority to European patent application no. 23 165 995.4 filed Mar. 31, 2023, the disclosure of which is incorporated herein by reference in its entirety for all purposes.

### TECHNICAL FIELD

The invention relates to a test arrangement for detecting a substance.

### BACKGROUND

Test arrangements for detecting a substance are known in practice and include, for example, a container, in which a test liquid is held. The arrangement is also equipped with a test swab, such as a cotton swab or similar, by which the substance can be obtained from a surface, such as from the mucous membrane of a person or from a laboratory bench. The test swab is then dipped into the test liquid in the container and is made to react therewith. The substance can be detected using a measuring strip or by a color change of the test liquid mixed with the substance. Such a test arrangement can be used to detect certain chemical and/or biological substances or materials.

### SUMMARY

Disclosed herein is a test arrangement for the detection of a chemical and/or biological substance, having by a compact structure and which enables a reaction-stable storage of a test liquid.

According to one aspect of the disclosure, a test arrangement for the detection of a chemical and/or biological substance is therefore proposed. The test arrangement comprises a plastic sleeve, an ampule which contains a test liquid and which is disposed in the plastic sleeve, a container having a mixing space for holding and for mixing the test liquid and the substance, and an activation element whose actuation causes a breaking open of the ampule so the test liquid is released to the mixing space, and a test swab for obtaining the substance and for being immersed in the mixing space.

This test arrangement enables the stable storage of a test liquid by the ampule, which is disposed in the plastic sleeve and is made in particular of glass or a reaction-stable plastic breakable in a defined manner. The mixing space, which is formed by the container of the test arrangement, is in flow connection with a holding area of the plastic sleeve, in which the ampule is disposed, which can be broken open by actuating the activation element. Ideally, the handling of the test liquid, which is disposed in the ampule in the delivery state, is consequently sealed off from the environment. In the mixing space, the test liquid reacts with the substance which is introduced into the mixing space by the test swab. The substance is detected, for example, via a defined color change of the test liquid or by applying the test liquid which has reacted with the substance to a test strip, which test liquid undergoes a color change when the substance is present.

In principle, this test arrangement is suitable for detecting any substances which can react with a test liquid, the test liquid undergoing a color change as a result of the reaction and/or the test liquid to which the substance to be detected has been applied also being able to be applied to a test strip, which then undergoes a color change at least in a defined area when the substance to be detected is present.

The container having the mixing space is preferably made of plastic or glass.

In a special embodiment of the test arrangement, the plastic sleeve and the container are formed by a one-piece component. In particular, it is conceivable that the plastic sleeve and the container are disposed next to each other, one behind the other or one below the other.

In a further special embodiment of the test arrangement, the container is connected in a detachable manner to the plastic sleeve and the mixing space of the container is connected to a holding area of the plastic sleeve, in which the ampule is disposed, via a transfer opening, which is preferably formed on the plastic sleeve. For instance, the plastic sleeve has a bottom and/or a partition wall, which in particular can also follow a conical surface or the like and which is provided with at least one transfer opening, which enables the test liquid to flow from the holding area of the ampule into the mixing space.

The activation element of the test arrangement, by which the ampule can be opened to release the test liquid, can be designed in a variety of manners. For instance, the activation element comprises a ramp-like projection which is formed on the interior of the plastic sleeve and which, upon actuation of the activation element, interacts in such a manner with the ampule that a tip of the ampule is broken off.

Furthermore, the activation element can comprise an actuation button which can be pressed into the plastic sleeve and, for example, has a ramp on its interior, particularly a flat ramp, which also interacts with a tip of the ampule so that this tip can be broken off to open the ampule.

It is also conceivable that the activation element comprises defined pressure areas of the plastic sleeve. In particular, the pressure areas are elastically deformable so that a user of the test arrangement can break open the ampule by applying manual pressure in order to release the test liquid.

In order to be able to break open the ampule in a targeted manner, it is preferably designed as a glass or plastic ampule, which is provided with two breakable tips, in particular needle-like tips in the broad sense. The tips can be broken off at defined predetermined breaking points from an ampule body, which is in particular cylindrical in shape.

In order to be able to transfer the test liquid as effectively as possible from the holding area of the ampule to the mixing space of the container, a special embodiment of the test arrangement has a bulb which is formed on the plastic sleeve.

In order to improve the handling of the test arrangement, in particular in the embodiment in which the plastic sleeve and the container are formed by a one-piece component, the container can have a base. In this case, it is advantageous if the mixing space is disposed lower than the plastic sleeve or the ampule disposed in the plastic sleeve. The container can also have an insertion channel through which the substance to be detected can be introduced into the mixing space. The introduction channel can be disposed next to the plastic sleeve so that its axis is aligned parallel to the main axis of the plastic sleeve and/or the ampule.

In an advantageous embodiment, the container of the test arrangement is designed as a tube having an open end and a closed end, such as in the manner of a test tube. In this case, the container is preferably made of a transparent plastic or glass material, meaning in particular a color change of the test liquid during its reaction with the sample material is visible from the exterior.

In order to be able to dispense the test liquid which has been mixed with the substance in the mixing space from the container for further processing, the container can have a dispense opening and/or a spout in a special embodiment of the test arrangement.

The outlet opening is preferably equipped with a manual cap, which allows the outlet opening to be opened in a controlled manner.

In an embodiment in which the plastic sleeve and the container are disposed axially one behind the other, it is advantageous if the plastic sleeve has an apron which encloses the container. The apron serves as a holder for the container on the plastic sleeve and also to seal the transition between the plastic sleeve and the container. Of course, it is also conceivable that the container has an apron which grips the plastic sleeve in a corresponding manner.

In order to define the insertion depth of the container on the apron, the container can have a stop on its circumference which interacts with the apron.

In another special embodiment of the test arrangement, the apron together with an internal annular wall forms an annular groove into which an edge of the container is inserted. In this case, the container is designed in the manner of a test tube, for example.

In a particularly compact design of the test arrangement, the test swab is disposed and/or attached to the plastic sleeve so that it is immersed in the container. To collect the substance to be detected, the plastic sleeve together with the test swab can be detached from the container and be swabbed over a surface or biological tissue, for example. The test swab is then inserted back into the container and the plastic sleeve is connected to the plastic sleeve in a fluid-tight manner. The test arrangement can then be activated by actuating the activation element. The test liquid then flows into the mixing space, in which the test swab is also disposed. If the substance to be detected has actually been absorbed by the test swab, the test liquid changes color, for example, due to the chemical reaction of the substance with the test liquid.

The test swab is designed, for example, in the form of a cotton swab or other sampling swab.

To hold the test swab on the plastic sleeve, it can be provided with an annular wall which forms a receptacle for a shaft of the test swab.

The activation element of the test arrangement can further comprise an actuation button which can be pressed into the plastic sleeve and has a ramp on its inner side, in particular a flat ramp, which interacts with a tip of the ampule, so that upon actuation of the activation element and/or the activation button, the ramp moves onto the tip and breaks it off.

If the test liquid mixed with the substance is to be extracted from the mixing space to detect the substance, the container can be attached to a test plate which is provided with a test strip or the like. When the test strip is wetted with the test liquid, it undergoes a color change at least in certain areas if the substance to be detected is present.

In another special embodiment of the test arrangement, a valve is provided which controls a liquid flow between the mixing space of the container and a test space of the test plate in which the test liquid is conveyed after having mixed with the substance.

In particular, the valve can be actuated manually and preferably has a manually pressable actuation button for this purpose.

In order to enable compact storage of the test arrangement, the container can be pivotably attached to the test plate.

In order to enable a comparison between a test liquid subjected to the substance and a reference liquid, a container having a reference liquid can be disposed on the test plate. The reference liquid can be released by actuating a valve or the like.

Further advantages and advantageous embodiments of the object of the invention can be derived from the description, the drawings, and the claims.

### BRIEF DESCRIPTION OF THE FIGURES

Exemplary embodiments of a test arrangement according to the invention are shown in a schematically simplified manner in the drawing and are explained in more detail in the following description.

FIG. 1 shows a perspective top view of a first embodiment of the test arrangement.

FIG. 2 shows the individual parts of the test arrangement shown in FIG. 1.

FIG. 3 shows a side view of the test arrangement shown in FIG. 1.

FIG. 4 shows a longitudinal section through the test arrangement shown in FIG. 1 along line A-A in FIG. 3.

FIG. 5 shows a perspective view of a second embodiment of the test arrangement.

FIG. 6 shows the individual parts of the test arrangement shown in FIG. 5.

FIG. 7 shows a side view of the test arrangement shown in FIG. 5.

FIG. 8 shows a cut through the test arrangement shown in FIG. 5 along line A-A in FIG. 7.

FIG. 9 shows a perspective view of a third embodiment of the test arrangement.

FIG. 10 shows the individual parts of the test arrangement shown in FIG. 9.

FIG. 11 shows a longitudinal cut through the test arrangement shown in FIG. 9.

FIG. 12 shows a perspective view of a fourth embodiment of the test arrangement.

FIG. 13 shows the test arrangement shown in FIG. 12 as supplied.

FIG. 14 shows a side view of the test arrangement shown in FIG. 12,

FIG. 15 shows a longitudinal cut through the test arrangement of FIG. 12.

FIG. 16 shows the test arrangement shown in FIGS. 12 to 15 in a first application step.

FIG. 17 shows the test arrangement shown in FIGS. 12 to 15 in a second application step.

FIG. 18 shows the test arrangement shown in FIGS. 12 to 15 in a third application step.

FIG. 19 shows a fifth embodiment of a test arrangement.

FIG. 20 shows a longitudinal cut through an applicator of the test arrangement shown in FIG. 19.

FIG. 21 shows a sixth embodiment of a test arrangement.

FIG. 22 shows a longitudinal cut through an applicator of the test arrangement shown in FIG. 21.

FIG. 23 shows a perspective view of a seventh embodiment of a test arrangement.

FIG. 24 shows the test arrangement shown in FIG. 23 in the state prepared for use.

FIG. 25 shows a side view of the test arrangement shown in FIG. 23.

FIG. 26 shows a cut through the test arrangement shown in FIG. 23 along line A-A in FIG. 25.

FIG. 27 shows a second side view of the test arrangement shown in FIG. 23.

FIG. 28 shows a cut through the test arrangement shown in FIG. 23 along line B-B in FIG. 27 with an open outlet valve.

FIG. 29 shows a cut through the test arrangement shown in FIG. 23, corresponding to FIG. 28, but with a closed outlet valve.

FIG. 30 shows a perspective view of an eighth embodiment of a test arrangement.

FIG. 31 shows the test arrangement shown in FIG. 30 in the ready-to-use state.

FIG. 32 shows a longitudinal cut through the test arrangement shown in FIG. 30.

FIG. 33 shows a perspective view of a ninth embodiment of a test arrangement.

FIG. 34 shows the test arrangement shown in FIG. 33 in the ready-to-use state.

FIG. 35 shows a longitudinal cut through the test arrangement shown in FIG. 33.

FIG. 36 shows a perspective view of a tenth embodiment of a test arrangement.

FIG. 37 shows the test arrangement shown in FIG. 37 in the ready-to-use state.

FIG. 38 shows a longitudinal cut through the test arrangement shown in FIG. 36.

FIG. 39 shows a perspective view of an eleventh embodiment of a test arrangement.

FIG. 40 shows a side view of the test arrangement according to FIG. 39.

FIG. 41 shows a cut through the test arrangement shown in FIGS. 39 and 40.

FIG. 42 shows a perspective view of a twelfth embodiment of a test arrangement.

FIG. 43 shows a longitudinal cut through the test arrangement shown in FIG. 42 when in use.

### DETAILED DESCRIPTION

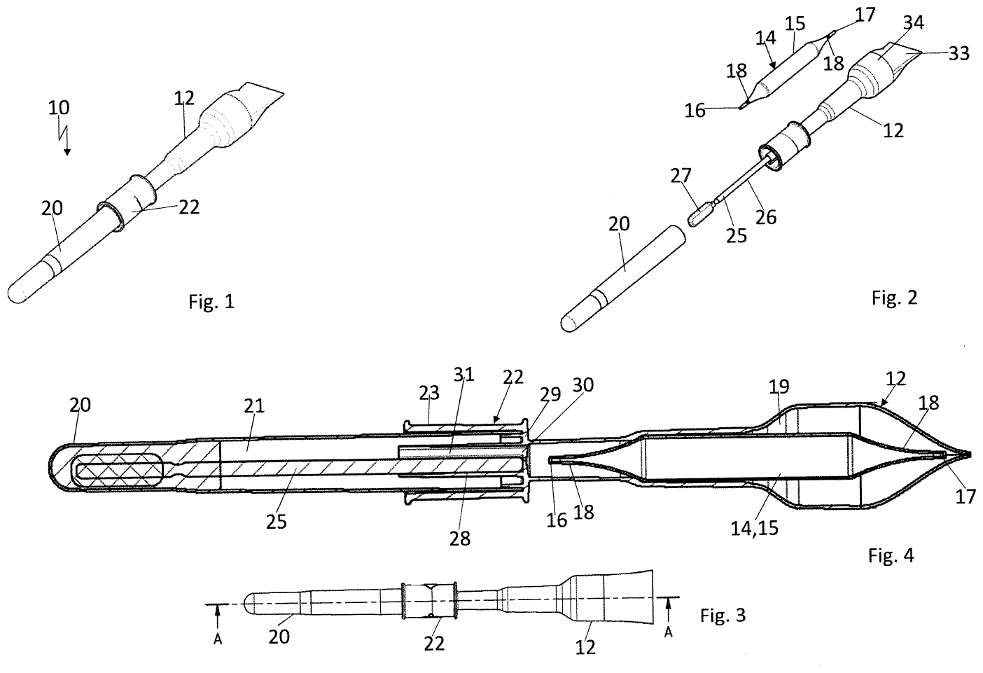

FIGS. 1 to 4 show a test arrangement 10 for detecting a chemical and/or biological substance or a chemical and/or biological material. The test arrangement 10 comprises a plastic sleeve 12, a glass ampule 14, which is designed as a so-called double-tipped ampule and thus comprises a cylindrical ampule body 15, which merges at each of its ends into a tip 16 and 17, in particular a needle-like tip, which can be broken off at a respective defined predetermined breaking point 18. The glass ampule 14 contains a test liquid and is disposed in a holding area 19 of the plastic sleeve 12. The front of the plastic sleeve 12 is coupled to a container 20, which is designed like a transparent test tube made of plastic or glass and defines a mixing space 21. For being coupled to the container 20, the plastic sleeve 12 has a coupling section 22 provided with an apron 23, which encloses the container 20 in its end area adjacent to the plastic sleeve 12. In addition, the coupling section 22 has an annular wall 24 which, together with the apron 23, defines an annular groove into which the edge of the container 20 adjacent to the plastic sleeve 12 is clamped.

The test arrangement 10 also comprises a test or substance swab 25, which has a shaft 26 and a holding area 27. The shaft 26 is received with its end area by a shaft receptacle 28 in a form-fitting manner, the shaft receptacle 28 being formed on the coupling section 22 of the plastic sleeve 12. In relation to the center axis of the test arrangement, the test swab 25 is disposed eccentrically, i.e., at an offset in the radial direction.

The coupling section 22 also forms a bottom 29 of the plastic sleeve 12, in which a transfer opening 30 is formed, which leads into a channel 31, which runs parallel to the shaft 26 of the test swab 25 and which in turn opens into the mixing space 21 of the container 20. A connection between the holding area 19 of the plastic sleeve 12 and the mixing space 21 of the plastic or glass container 20 is established via the transfer opening 30 and the channel 31.

Pressure areas 32 and 33 of the plastic sleeve 12 represent an activation element by means of which the glass ampule 14 can be opened or its tips 16 and 17 can be broken off.

In one application of the test arrangement 10, the test swab 25 attached to the plastic sleeve 12 is used to swab a surface so that material is absorbed which may contain the substance to be detected. The container 20 is then coupled to the plastic sleeve 12, i.e., latched or clamped to the coupling section 22 in the manner shown in FIG. 4. The tips 16, 17 are then broken off from the ampule 14 by applying manual pressure to pressure areas 32 and 33 of the plastic sleeve 12, meaning a test liquid absorbed by the ampule 14 is released into the holding area 19. The test liquid can now flow into the mixing space 21 of the container 20 via the transfer opening 30 and the channel 31, the holding area 27 thus being in the test liquid. The transfer of the test liquid into the mixing space 21 can be supported by means of a bulb-like end section 34 of the plastic sleeve 12. In the mixing space 21, the test liquid reacts with the material disposed on the holding area 27. If this contains the substance to be detected, the test liquid undergoes a defined color change. If there is no color change, the test is negative, i.e., the chemical and/or biological substance in question cannot be detected.

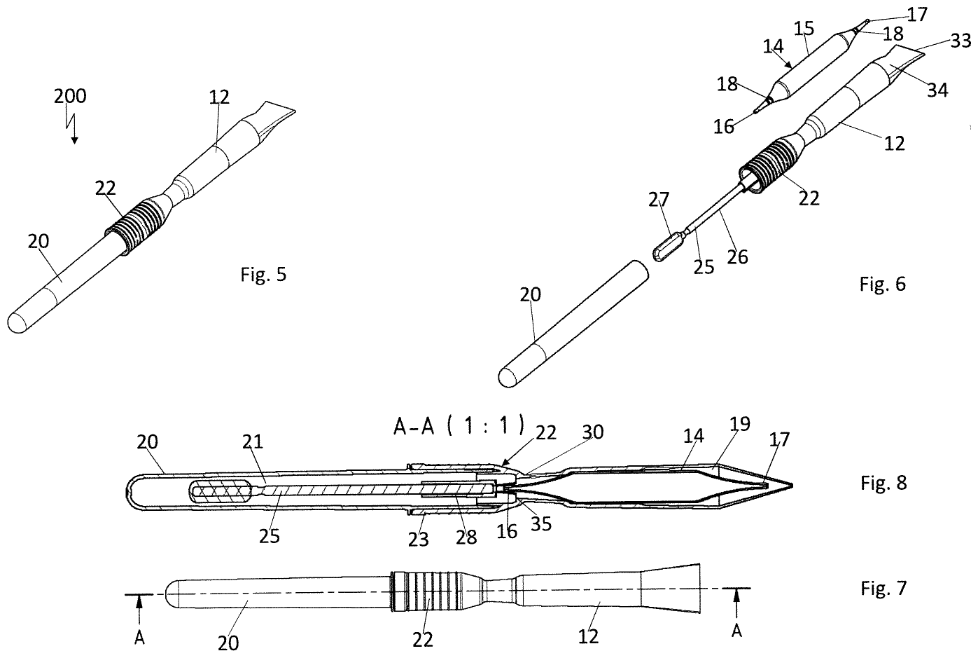

FIGS. 5 to 8 show a test arrangement 200 which essentially corresponds to the one shown in FIG. 1, but differs in the respect that the plastic sleeve 12 has a shaft receptacle 28 in its coupling section 22 facing the container 20, the axis of the shaft receptacle 28 coinciding with the main axis of the test arrangement 10, so that the test swab 25 also lies in the central axis of the test arrangement 200 with its shaft 26.

Furthermore, the plastic sleeve 12 of the test arrangement 200 comprises a bottom area 35, in which the tip 16 of the ampule 15 engages and which is equipped with several transfer openings 30, which are distributed along a circular line surrounding the tip 16 and which connect the holding area 19 of the plastic sleeve 12 with the mixing space 21 of the container 20. In addition, in contrast to the embodiment according to FIGS. 1 to 4, the plastic sleeve 12 does not have a bulb-like end section.

In all other respects, the test arrangement 200 corresponds to the one shown in FIGS. 1 to 4, for which reason reference is made to the relevant description in order to avoid repetition. The application of the test arrangement 200 also corresponds to the application of the test arrangement according to FIGS. 1 to 4.

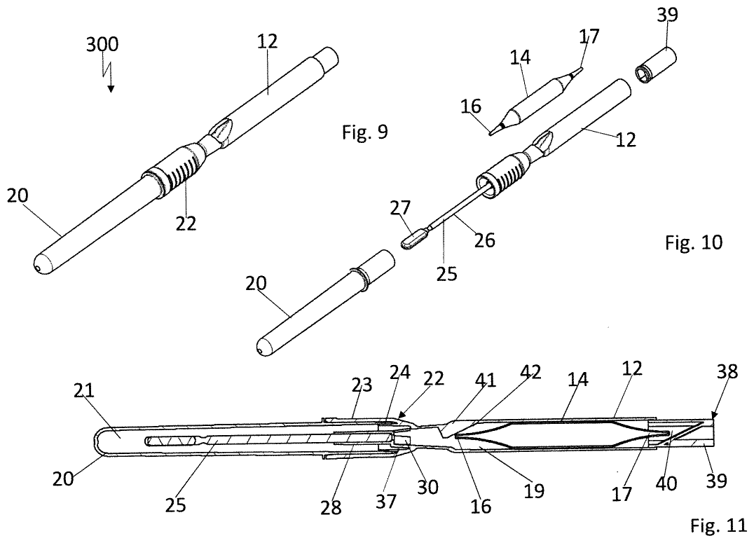

FIGS. 9 to 11 show a test arrangement 300, which also comprises a plastic sleeve 12 having a coupling section 22, a glass ampule 14 having two breakable tips 16 and 17 and an ampule body 15 connecting the two tips 16 and 17 to one another, as well as a test tube-like container 20 and a test swab 25 having a shaft 26 and a holding area 27. A coupling section 22 also comprises an apron 23 and an annular wall 24, between which an edge section of the container 20 is clamped. In addition, the container 20 has an annular collar 36, which determines the insertion depth of the container 20 into the coupling section 22 of the plastic sleeve 12.

The shaft 26 of the test swab 25 is inserted into a tubular shaft receptacle 28, which is also formed on the coupling section 22 of the plastic sleeve 12.

Connected to the shaft receptacle 28, an internal wall 37 is formed on the plastic sleeve 12, follows a conical surface and has several window-like transfer openings 30 formed all around, which establish a connection between a holding area 19 of the plastic sleeve 12 and a mixing space 21 of the container 20.

The test arrangement 300 is also provided with an activation element 38, which on the one hand comprises an actuation button 39, which is slidably mounted in the plastic sleeve 12 and has a ramp 40 on the interior, in particular a flat ramp 40, which is used to break off the tip 17 of the ampule 14. On the other hand, the activation element 38 comprises a ramp 42 which is formed on a projection 41 and serves to break off the tip 16 of the ampule 14.

In accordance with the use of the test arrangements shown in FIGS. 1 to 8, when using the test arrangement 300, the holding area 27 of the test swab 25 attached to the plastic sleeve 12 is first passed over a surface to be examined in order to collect material. The container 20 is then put over the test swab 25 in the manner shown in FIG. 11 and fixed to the coupling section 22. The activation element 38 is then actuated, i.e., the actuation button 39 is pressed axially into the plastic sleeve 12 so that the tip 16 moves onto the ramp 42 and is broken off and the ramp 40 moves onto the tip 17 and breaks it off. This releases the test liquid held in the ampule 14, meaning it can flow from the holding area 19 into the mixing space 21 of the container 20 via the transfer openings 30. The holding area 27 of the test swab 25 is pressurized with the test liquid. The test liquid can react with a material disposed on the holding area 27. If the substance to be detected is present, the test liquid undergoes a color change, which can be detected visually by the user. Without a color change, the test is negative, i.e., the substance in question cannot be detected.

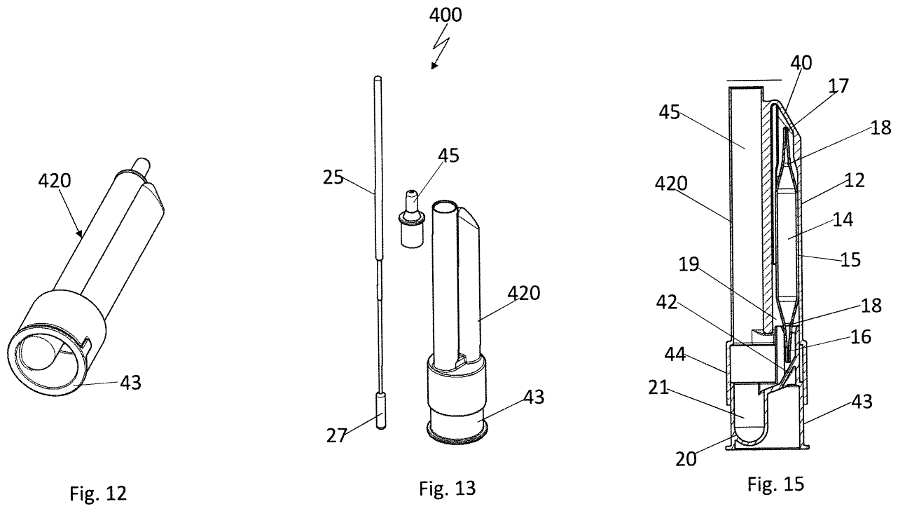

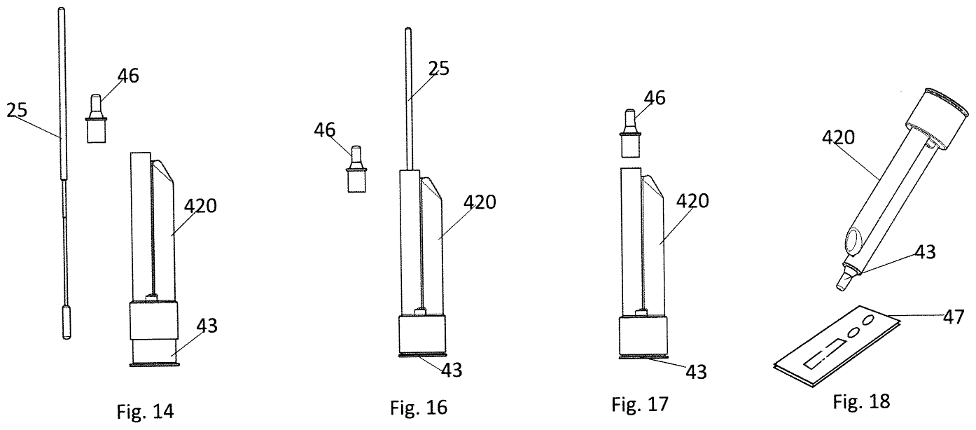

FIGS. 12 to 18 show a test arrangement 400 which is also suitable for detecting a chemical and/or biological substance. The test arrangement 400 comprises a casing 42, which has a plastic sleeve 12 having a holding area 19 for holding a glass ampule 14, which comprises an ampule body 15 and two tips 16 and 17, each of which can be broken off from the ampule body 15 via a defined predetermined breaking point 18.

Furthermore, the casing 42 comprises an insert 43, which represents a container 20 in which a mixing space 21 is formed. The insert 43 can be displaced relative to a casing section 44 of the casing 42 forming the plastic sleeve 12. In particular, the insert 43 can be pressed into the casing section 44 in order to activate the test arrangement 400.

To form an activation element, the insert 43 has a ramp 42 which interacts with the tip 16 of the ampule. The end face of the plastic sleeve 12 which faces away from the insert 43 and is formed by the casing section 44, also forms a ramp 40 which interacts with the tip 17 of the ampule 14. The insert 43, which forms the container 20, is therefore also part of the activation element.

The casing section 44, which holds the ampule 14 in the holding area 19, forms a channel 45 parallel to the holding area 19, a test swab 25, on which a holding area 27 is formed, being able to be introduced into the mixing space 21 via the channel 45 and a test liquid contained in the mixing space 21 being able to be applied to a test cassette 46, which is provided with an indicator strip, by means of a dosing cap 46, which can be inserted into an end face of the channel 45.

The test arrangement 400 is used in such a manner that a sample is first obtained using the test swab 25. The holding casing 420 is then activated by pressing the insert 43 into the casing section 44. As a result, the tips 15 and 17 of the ampule 14 are broken off by the ramps 40 and 42 and the test liquid held in the ampule 14 is released into the mixing space 21. The test swab 25 is immersed in the mixing space 20 via the channel 45 so that the material disposed on the holding area 27 can react with the test liquid (see FIG. 16). The test swab 25 is then removed again from the holding casing 420 so that the dosing cap 46 can be fitted (see FIG. 17) and the test liquid can be applied to the test cassette 47 via the dosing cap 46. If the test strip of the test cassette 47 then undergoes a color change at least in some areas, a specific substance has been detected. Without a color change, the substance in question has not been detected.

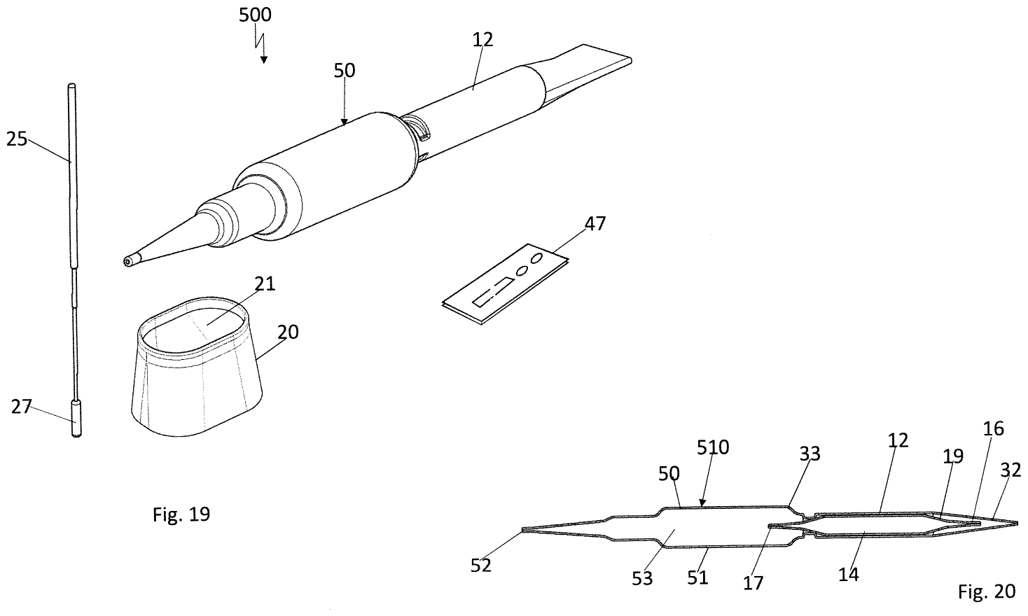

FIGS. 19 and 20 illustrate a test arrangement 500 having a plastic tube 510 forming a plastic sleeve 12 in which a holding area 19 for an ampule 14 of the type described in connection with the preceding embodiments is formed. In addition, the plastic tube 510 comprises a pipette section 50 provided with a bulb area 51 and a pipette tip 52. Separate from the plastic tubes 510, the test arrangement 500 comprises a container 20, which is designed like a small trough and has a mixing space 21. In addition, the test arrangement 500 comprises a test swab 25 having a holding area 27.

A test cassette 47 having a test or indicator strip is also provided.

As an activation element for breaking off the tips 16 and 17 of the ampule 15, the plastic tube 510 comprises defined pressure areas 32 and 33, via which a user can break off the tips 16 and 17 to release the test liquid held in the ampule 14.

When using the test arrangement 500, a surface and/or tissue is first swabbed with the test swab 25 in order to collect a sample or material. The ampule 14 is then broken open via the pressure areas 32 and 33 so that the test liquid flows into an interior 53 of the pipette section 50 of the plastic tube 10. The test liquid is then added to the mixing space 21 of the container 22 by manually pressing the bulb area 51 via the pipette tip 52. The test swab 25 with its holding area 27 is then immersed in the test liquid in the mixing space 21. After a defined dwell time, the test swab 25 is removed again and the test liquid mixed with the sample is drawn into the pipette section 50 of the plastic tube 510. This can then be added to the test cassette 47 in defined droplets. If at least some areas of the test strip of the test cassette undergo a color change, a specific substance contained in the sample has been detected. Without a color change, there is no detection.

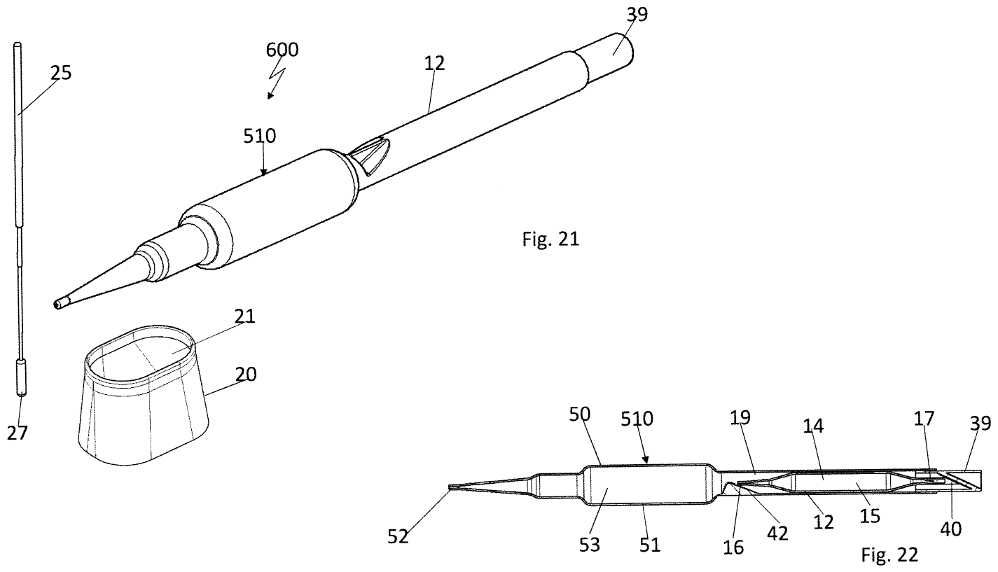

FIGS. 21 and 22 show a test arrangement 600 which essentially corresponds to the one shown in FIGS. 19 and 20, but differs only in the respect that it has an actuation button 39 on the plastic tube 510 as an activation element, the actuation button 39 being provided with a ramp 40 which interacts with the tip 17 of the ampule 14, the actuation button 39 being able to be pressed into the holding area intended for the ampule 14 and forming a plastic sleeve 12. To break off the tip 16 of the ampule 14, another ramp 42 is formed in the holding area 19 of the plastic sleeve 12, the tip 16 moving onto the ramp 42 when the actuation button 39 is pressed. Consequently, the tips 16 and 17 are broken off the ampule body 15 by means of the ramps 40 and 42 when pressing the actuation button 39.

The application and use of the test arrangement 600 corresponds to the test arrangement according to FIGS. 19 and 20, for which reason reference is made to the relevant description in order to avoid repetition.

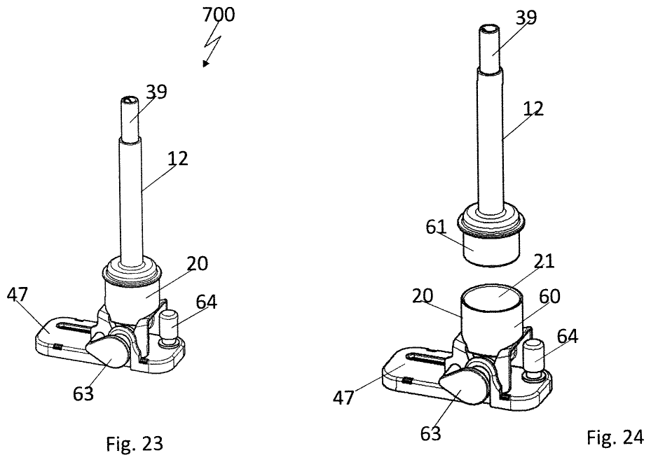

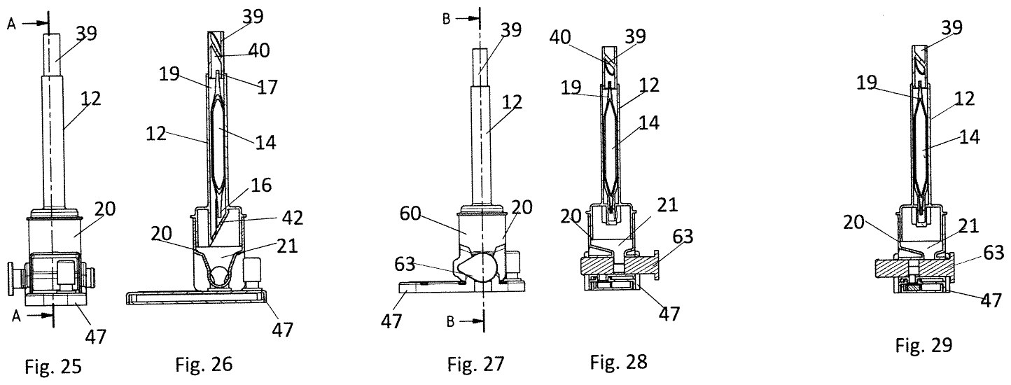

FIGS. 23 to 29 show a test arrangement 700 which has a carrier plate designed as a test cassette 47 on which a container 20 is disposed which encloses a mixing space 21. The container 20 has an annular wall 60.

In the assembled state of the test arrangement 700, a plastic sleeve 12 is inserted into the annular wall 60 of the test arrangement 700, which is provided with a coupling section 22 having an annular wall 61 whose outer diameter corresponds to the inner diameter of the annular wall 60 of the container 20. The plastic sleeve 12 forms a holding area 19 for an ampule 14, which also has two tips 16 and 17, which delimit the end of a cylindrical ampule body 15.

As an activation element, the test arrangement 700 comprises an actuation button 39, which can be pressed into the holding area 19 of the plastic sleeve 12 and has a ramp 40 on the inside, which interacts with the tip 17 of the ampule 14. On the side facing away from the actuation button 39, the plastic sleeve 12 has another ramp 42 in the area of the coupling section 22, which interacts with the other tip 16 of the ampule 14.

A transfer channel 62 is located between the mixing space 21 and the test cassette 47 of the test arrangement 700, the transfer channel 62 being able to be opened or closed as required by means of a manually operated slide valve 63.

In addition, a container 64 for reference liquid is disposed on the test cassette 47. By applying vertical axial pressure to the container 64, the reference liquid contained therein can be released in the direction of the test strip of the test cassette 47.

When using the test arrangement 700 to detect a chemical and/or biological substance, the plastic sleeve 12 is first removed from the container 20. The user can then introduce their sputum or another sample from above into the mixing space 21 of the container 20. The plastic sleeve 12 is then replaced on the container 20. The user then presses the actuation button 39 in the axial direction, causing the tips 16 and 17 of the ampule 14 to break off and the test liquid contained therein flows downwards into the mixing space 21 and mixes with the sputum. After a particularly defined dwell time, the slide valve 63 is actuated so that the fluid flow between the mixing space 21 and the test cassette 47 is released and the test strip of the test cassette 47 can be used to determine whether a specific substance, for example a virus, is present in the sputum. Detection is achieved by the test strip undergoing a color change. If necessary, the test result can be checked using the reference liquid by pressing the container 64.

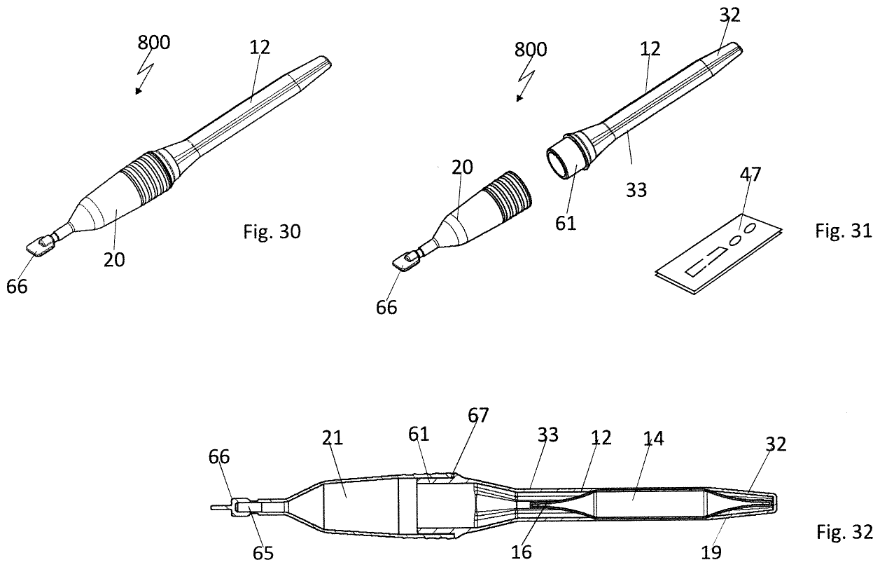

FIGS. 30 to 32 show a test arrangement 800 which comprises a plastic sleeve 12 having a holding area for holding an ampule 14 and a container 20 in which a mixing space 21 is formed. The container 20 also has a dispense opening 65, which is closed by means of a cap. Alternatively, the dispense opening 65 can also be closed by means of an integrally molded cap which can be twisted off. The test arrangement 800 also has a test cassette 47 with test strips. The plastic sleeve 12 has two defined pressure areas 32 and 33. By exerting manual pressure on the pressure areas 32 and 33, tips 16 and 17 of the ampule 14 can be broken off at defined predetermined breaking points, meaning a test liquid held in the ampule is released.

When using the test arrangement 800, the user first removes the plastic sleeve 12 from the container 20 so that they can introduce sputum or even a different sample into the mixing space 21 of the container 20. The user then re-inserts the plastic sleeve 12 into the container 20 so that an annular wall 61 of the plastic sleeve 12 rests against a corresponding annular wall of the container 20 from the interior. The insertion depth is determined by an annular collar 67 which is formed on the plastic sleeve 12.

The user then presses on the pressure areas 32 and 33, which represent an activation element, so that the tips 16 and 17 of the ampule 14 are broken off and the test liquid flows out of the ampule 14 into the mixing space 21, where it mixes with the sputum. If necessary, the mixing process can be supported by shaking the arrangement. The cap 66 is then removed and the mixture of the test liquid and the sputum is dispensed onto the test cassette 47. If a specific substance, for example a virus, is present in the sputum, at least some areas of the test strip of the test cassette 47 change color. This makes it possible to detect this substance, i.e., the virus.

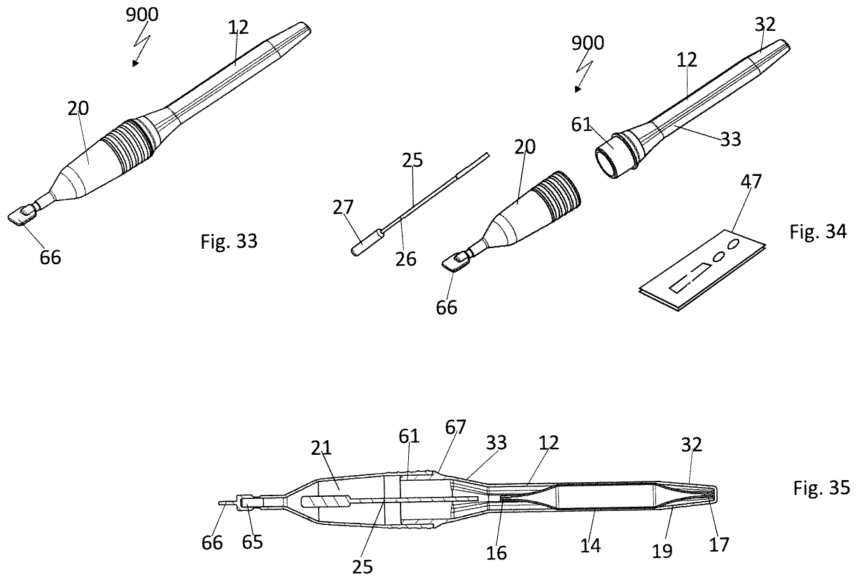

FIGS. 33 to 35 show a test arrangement 900 which largely corresponds to the one shown in FIGS. 30 to 32, but differs in the respect that it also has a test swab 25 which has a holding area 27 and a shaft 26.

With regard to the structure, the test arrangement 900 also corresponds to the one shown in FIGS. 30 to 32.

However, in contrast to the test arrangement shown in FIGS. 30 and 32, the sample is obtained by means of the test swab 25, for example from the nasal mucous membrane of a user. The test swab 25 is then inserted into the container 20 in the manner shown in FIG. 35, so that the holding area 27 of the test swab 25 lies in the mixing space 21. When the ampule 14 is opened by breaking off the tips 16 and 17, the holding area 27 of the test swab 25 is surrounded by the test liquid so that the sample present on the holding area 27 can react with the test liquid. After removing the cap 66, the test liquid is then applied to the test cassette 47 so that the test strip of the test cassette 47 can be used to detect a substance contained in the sample.

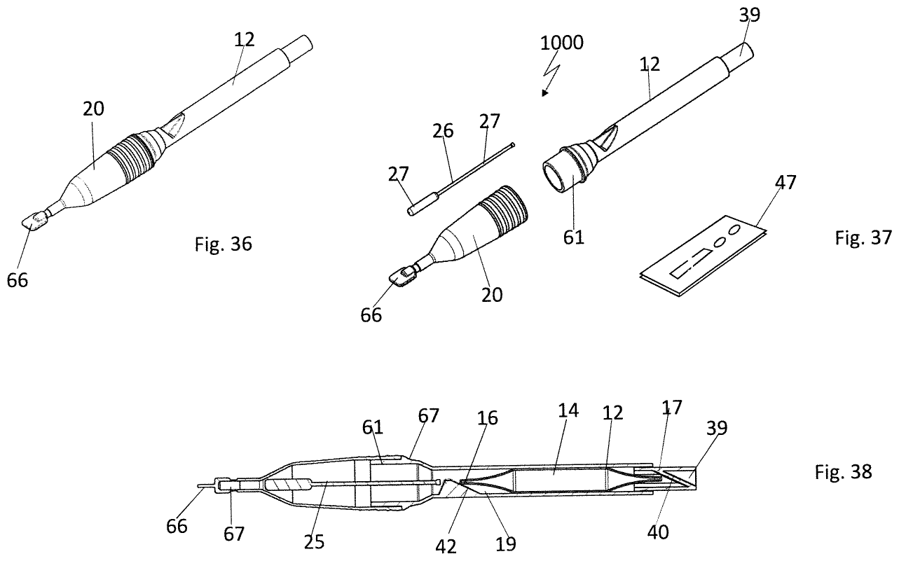

FIGS. 36 to 38 show a test arrangement 1000 which essentially corresponds to the one shown in FIGS. 33 to 35, but differs in the respect that the plastic sleeve 12 has an actuation button 39 with an internal ramp 40 as an activation element, the actuation button 39 interacting with a ramp 42 formed in one piece on the inside of the plastic sleeve 12 in such a manner that when the actuation button 39 is displaced into the plastic sleeve 12, the tip 17 is broken off by means of the ramp 40 and the tip 16 of the ampule 14 is broken off by means of the ramp 42, meaning the test liquid held in the ampule 14 can flow into the mixing space 21 of the container 20, so that the holding area 27 of the test swab 25 is surrounded by the test liquid.

Apart from this, the structure and application of the arrangement 1000 correspond to the structure and application of the test arrangement according to FIGS. 33 to 35, so that reference is made to the relevant description in order to avoid repetition.

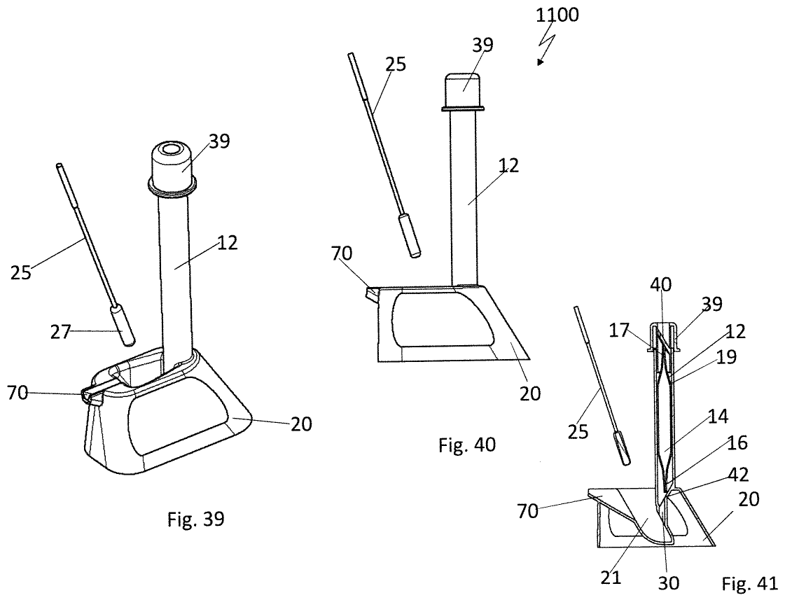

FIGS. 39 to 41 show a test arrangement 1100 which has a plastic sleeve 12 which holds a holding area 19 for a glass ampule 14 of the type mentioned in the examples described above. The plastic sleeve 12 is disposed on a trough-like container 20, by means of which it can be manufactured in one piece. The container 20 has a mixing space 21 which is provided with a spout 70 and is open at the top.

On the side facing away from the container 20, the plastic sleeve 12 has an actuation button 39 as an activation element, which is provided on the interior with a ramp 40, which interacts with a tip 17 of the ampule 14. On the side facing away from the actuation button 39, the plastic sleeve 12 has a ramp 42, which is formed by a bottom surface.

In addition, the test arrangement 1100 is equipped with a test swab 25, which also has a holding area 27.

During use, a sample is obtained from a surface or tissue using the test swab 25. The actuation button 39 is then pressed down so that the tips 16 and 17 of the ampule 14 break off by means of the ramps 40 and 42, and the test liquid contained in the ampule 14 flows out of the plastic sleeve 12 into the mixing space 21 of the container 20 via a transfer opening 30. The test swab 25 with its holding area 27 is then immersed in the test liquid in the mixing space 21, stirring if necessary.

The test liquid can then be dispensed via the spout 70 onto a test cassette 47 with test strips so that the detection of a substance taken up by the test swab 25 is possible. If a color change occurs on the test strip, the substance is detected. Without a color change, no detection occurred.

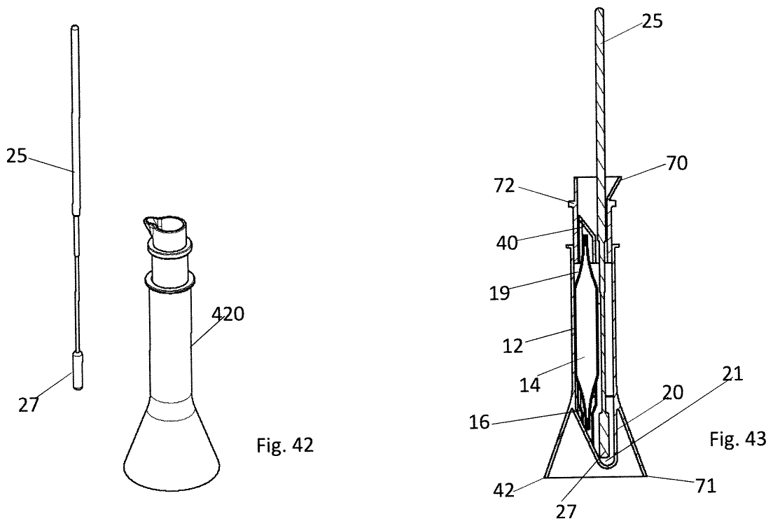

FIGS. 42 and 43 show a test arrangement 1200 which has a holding casing 420 with a base 71 formed by a cone-like wall which is formed on a container 20 which forms a mixing space 21. A plastic sleeve 12 is integrally formed on the container 20 and has a holding area 19 for a glass ampule 14, which is formed in accordance with the glass ampule of the embodiments described above.

In addition, the test arrangement 1200 has an insert 72 at the top, which is provided with an activation element in the form of a ramp 40 and a spout 70. The ramp 40 is formed by an internal, inclined partition wall.

On the side facing away from the insert 72, which can be axially displaced in the plastic sleeve 12, the container 20 has another ramp 42, which interacts with the tip 16 of the ampule 14, due to an inclined boundary wall of the mixing space 21.

The diameter of the plastic sleeve 12 is selected so that a test swab 25 with its holding area 27 can be inserted past the ampule into the mixing space 21 via the tube-like insert 72; the outer diameter of the ampule 15 is therefore smaller than the inner diameter of the plastic sleeve 12.

When using the test arrangement 1200, a sample is first obtained using the test swab 25. The holding area 27 of the test swab 25 is then inserted into the mixing space 21 in the manner described above via the insert 72 and the free space between the ampule 14 and the circumferential wall of the plastic sleeve 12. The insert 72 is then pressed into the plastic sleeve 12 so that the tips 16 and 17 of the ampule 14 are broken off by means of the ramps 40 and 42 and the test liquid held in the ampule 14 flows into the mixing space 21. In particular after a defined dwell time, the test swab 25 can then be removed and the test liquid can be dispensed via the spout 70 onto a test cassette 47. If the substance to be detected is present in the sample, the test strip of the test cassette 47 undergoes a color change. Otherwise there is no color change.

### LIST OF REFERENCE SYMBOLS

10 test arrangement
12 plastic sleeve
14 glass ampule
15 ampule body
16 tip
17 tip
18 predetermined breaking point
19 holding area
20 container
21 mixing space
22 coupling section
23 apron
24 annular wall
25 test swab
26 shaft
27 holding area
28 shaft receptacle
29 bottom
30 transfer opening
31 channel
32 pressure area
33 pressure area
34 end section
35 bottom area
36 annular collar
37 wall
38 activation element
39 actuation button
40 ramp
41 projection
42 ramp
43 insert
44 casing section
45 channel
46 dosing cap
47 test cassette
50 pipette section
51 bulb area
52 pipette tip
60 annular wall
61 annular wall
62 transfer channel
63 slide valve
64 container
65 dispense opening
66 cap/cap
67 annular collar
70 spout
71 foot section
72 insert
200 test arrangement
300 test arrangement
400 test arrangement
420 holding casing
500 test arrangement
510 plastic tubes
600 test arrangement
700 test arrangement
800 test arrangement
900 test arrangement
1000 test arrangement
1100 test arrangement
1200 test arrangement

What is claimed is:

1. A test arrangement for the detection of a substance, the test arrangement comprising a plastic sleeve, an ampule which holds a test liquid and which is disposed in the plastic sleeve, a container having a mixing space for holding and for mixing the test liquid and the substance, an activation element whose actuation causes a breaking open of the ampule so the test liquid is released to the mixing space, and a test swab for being immersed in the mixing space.

2. The test arrangement according to claim 1, wherein the plastic sleeve and the container are formed by a one-piece component.

3. The test arrangement according to claim 1, wherein the container is connected in a detachable manner to the plastic sleeve and the mixing space of the container is connected via a transfer opening to a holding area of the plastic sleeve, in which the ampule is disposed.

4. The test arrangement according to claim 3, wherein the transfer opening is formed on the plastic sleeve.

5. The test arrangement according to claim 1, wherein the plastic sleeve has a ramp-like projection on the interior, the projection interacting in such a manner with the ampule upon actuation of the activation element that a tip of the ampule is broken off.

6. The test arrangement according to claim 1, wherein the activation element comprises defined pressure areas of the plastic sleeve.

7. The test arrangement according to claim 1, wherein the plastic sleeve comprises a bulb or a bulb-like end section.

8. The test arrangement according to claim 1, wherein the container has a base.

9. The test arrangement according to claim 1, wherein the container has a dispense opening.

10. The test arrangement according to claim 9, wherein the dispense opening is equipped with a manually detachable cap.

11. The test arrangement according to claim 1, wherein the container has a dispense opening a spout.

12. The test arrangement according to claim 1, wherein the plastic sleeve has an apron, which encloses the container.

13. The test arrangement according to claim 12, wherein the container has a stop on its circumference which interacts with the apron.

14. The test arrangement according to claim 1, wherein the test swab is fastened on the plastic sleeve and is immersed in the container.

15. The test arrangement according to claim 1, wherein the test swab is inserted in a shaft receptacle of the plastic sleeve.

16. The test arrangement according to claim 1, wherein the activation element comprises an actuation button, which is pressed into the plastic sleeve and has a plane ramp on its interior, the ramp interacting with a tip of the ampule.

17. The test arrangement according to claim 1, wherein the container is fastened on a test cassette.

18. The test arrangement according to claim 17, wherein the test cassette is equipped with a test strip.

19. The test arrangement according to claim 17, further comprising a valve which controls a liquid flow between the mixing space of the container and a test space of the test cassette and which has a manually pressable actuation button.

20. The test arrangement according to claim 17, wherein a container having a reference liquid is disposed on the test cassette.
